(19) United States
(12) Patent Application Publication
(10) Pub. No.: US 2022/0153130 A1
(43) Pub. Date: May 19, 2022

(54) Tank Mounting Adapter

(71) Applicant: Tuthill Corporation, Fort Wayne, IN (US)

(72) Inventors: Jacob John Berry, Uniondale, IN (US); Seth Alan Heyde, Huntington, IN (US)

(21) Appl. No.: 17/525,218

(22) Filed: Nov. 12, 2021

Related U.S. Application Data
(60) Provisional application No. 63/114,007, filed on Nov. 16, 2020.

(51) Int. Cl. B60K 15/073

(52) U.S. Cl. CPC B60K 15/073; B60K 2015/03453

(57) ABSTRACT

A tank mounting adapter is provided that includes a tank adapter disc and a compression nut. The tank adapter disc includes an opening disposed therethrough, which may be sized to receive at least a portion of the support structure of the fluid pump. The compression nut may include a collar with a threaded opening disposed therethrough such that threads of the threaded opening are configured to correspond to threads on the support structure of the fluid pump. The compression nut may be located adjacent the tank adapter disc. The collar may further include a lower portion that extends into the opening of the tank adapter disc. The compression nut may be movable with respect to the tank adapter disc and against the tank adapter disc.

### RELATED APPLICATIONS

The present Application relates to and claims priority to U.S. Provisional Patent Application, Ser. No. 63/114,007, filed on Nov. 16, 2020, entitled “Tank Port Saver.” The subject matter disclosed in that Provisional Application is hereby expressly incorporated into the present Application.

### TECHNICAL FIELD AND SUMMARY

The present disclosure relates to fluid pump mountings, and particularly to a mounting adapter for a fuel tank to support a cantilevered or like pump assembly.

Portable fluid pumps, such as a portable fuel transfer pump assembly, typically include inlet and outlet manifolds connected to a pump housing. The inlet manifold may be threaded to removably attach onto a fuel or other liquid tank. The opening of the tank that receives the inlet manifold is often referred to as a tank port or bung. With the inlet manifold threadably fastened onto the tank port, the pump portion of the pump assembly, as well as the outlet manifold, typically set on top in a generally vertical orientation above the tank port. The fuel transfer pump assembly may also include a motor, electronics, and a nozzle support assembly that all typically extend laterally from the pump housing. This means much of the weight of the fuel transfer pump is cantilevered from the pump assembly portion that is sitting directly above the tank port.

For several fuel tank applications, the threaded tank port supporting the manifold of the pump housing, along with the associated motor, electronics, and nozzle structures cantilevered therefrom, is not an issue. For some aluminum-constructed tanks, however, the cantilevered weight of the motor, electronics, and nozzle structures may be substantial enough to cause fatigue and failure at the weld between the threaded tank port and the tank itself. This weld about the periphery of the threaded tank port secures the port to the tank and may be susceptible to fractures at this juncture, possibly resulting in failure. A common cause of this failure is the presence of a stress concentration where the weld and the tank substrate meet, at which point a fracture may begin to form and propagate due to fatigue.

Accordingly, an illustrative embodiment of the present disclosure provides a tank mounting adapter to be located adjacent a support structure of a fluid pump that attaches to a fluid tank wherein the support structure supports the fluid pump on the fluid tank. The tank mounting adapter comprises a tank adapter disc and a compression nut. The tank adapter disc includes an opening disposed therethrough and sized to receive at least a portion of the support structure of the fluid pump. The compression nut includes a collar with a threaded opening disposed therethrough such that threads of the threaded opening are configured to correspond to threads on the support structure of the fluid pump. The compression nut is located adjacent the tank adapter disc. The collar includes a lower portion that extends into the opening of the tank adapter disc. The compression nut is rotationally and linearly movable with respect to the tank adapter disc and against the tank adapter disc. And the tank adapter disc is extended in a direction transverse from the threaded opening of the compression nut.

In the above and further embodiments, the tank mounting adapter may further comprise: an O-ring located on the tank adapter disc opposite the compression nut; an O-ring located at least partially within a cavity formed on an underside of the tank adapter disc opposite the compression nut; the O-ring being located at least partially within a cavity formed on an underside of the tank adapter disc opposite the compression nut; the O-ring being made of a resilient material; the compression nut further comprising at least one tab extending therefrom; the at least one tab being a plurality of tabs, wherein each of the plurality of tabs being spaced apart from each other and extending outwardly from the compression nut; the lower portion of the collar that extends into the opening of the tank adapter disc being also located adjacent a periphery of the opening of the tank adapter disc; the compression nut exerting a downward force against the tank adapter disc; at least a portion of the tank adapter disc having a concave shape; the concave shape of the at least the portion of the tank adapter disc being located opposite of at least a portion of the compression nut; and the tank adapter disc having a shape that is selected from the group consisting of at least one of an oval, a square, and a rectangle.

Another illustrative embodiment of the present disclosure provides a tank mounting adapter that comprises a tank adapter disc and a compression nut. The tank adapter disc includes an opening disposed therethrough. The compression nut includes a collar with a threaded opening disposed therethrough. The compression nut is located adjacent the tank adapter disc. And the compression nut is movable against the tank adapter disc.

In the above and further embodiments, the tank mounting adapter may further comprise: the collar including a lower portion that extends into the opening of the tank adapter disc; the compression nut being rotationally and linearly movable with respect to the tank adapter disc; and the tank adapter disc being extended in a direction transverse from the threaded opening of the compression nut.

Another illustrative embodiment of the present disclosure provides a tank mounting adapter that comprises a tank adapter disc and a compression nut. The tank adapter disc includes an opening disposed therethrough. The compression nut includes a collar with a threaded opening disposed therethrough. And the compression nut is movable against the tank adapter disc.

In the above and further embodiments, the tank mounting adapter may further comprise: the compression nut being located adjacent the tank adapter disc; the tank adapter disc being extended in a direction transverse from the threaded opening of the compression nut; and the collar including a lower portion that extends into the opening of the tank adapter disc.

Additional features and advantages of the tank mounting adapter assembly will become apparent to those skilled in the art upon consideration of the following detailed descriptions exemplifying the best mode of carrying out the tank mounting adapter assembly as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective view of a fluid transfer pump attached to an illustrative fluid tank with a mounting adapter assembly attached thereto;

FIG. 2 is a perspective view of a fluid tank;

FIG. 3 is a perspective detail view of a portion of the fluid tank from FIG. 2;

FIG. 4 is a prior art, partial cross-section, side elevational view of a portion of a fluid tank with a fluid transfer pump coupled thereto;

FIG. 5 is a perspective view of a mounter adapter assembly;

FIG. 6 is a side elevational view showing a portion of the fluid tank in cross-section with a fluid transfer pump coupled to the tank port and a mounting adapter assembly installed thereon;

FIG. 7 is an exploded view of a mounting adapter assembly;

FIG. 8 is a top view of the mounting adapter assembly;

FIG. 9 is a side view of the mounting adapter assembly; and

FIG. 10 is an underside view of the mounting adapter assembly.

Corresponding reference characters indicate corresponding parts throughout the several views. The exemplification set out herein illustrates embodiments of the tank mounting adapter assembly, and such exemplification is not to be construed as limiting the scope of the tank mounting adapter assembly in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Accordingly, an illustrative embodiment of the present disclosure provides a tank mounting adapter assembly that attaches illustratively to the inlet manifold of the fluid transfer pump and engages the surface of the fuel tank about a spaced apart periphery of the threaded tank port. The threads of the inlet manifold engage the threads of the tank port like normal, but a compression nut of the tank mounting adapter assembly also threads onto the inlet manifold at a location above the tank port. The tank mounting adapter assembly includes a tank adapter disc that is forcibly pressed against the tank wall by a threaded compression nut. The engagement between the threads of the inlet manifold and the compression nut creates a downward force on the tank adapter disc against the tank wall. This downward force against the tank wall counteracts the moment of force created at the threaded tank port by the downward force from the cantilevered motor, electronics, and nozzle assemblies of the fluid transfer pump. By counteracting this moment of force, less stress is applied at the tank weld located about the threaded tank port, thereby reducing the risk of fatigue and fracture of the tank port at this area. This expands the usefulness of the cantilevered fuel transfer pump assembly for applications that might otherwise have not been available for use.

An embodiment of the tank mounting adapter assembly may include a tank adapter disc, compression nut, and resilient O-ring. The compression nut may have threads that correspond to the threads on the inlet manifold. The threaded periphery of the inlet manifold should be sufficient to receive both the threaded tank port on the fuel tank and the compression nut. The tank adapter disc includes an opening that also receives the inlet manifold and is positioned adjacent the compression nut. In use, the compression nut is movable linearly by rotating on the threads of the inlet manifold to act on the tank adapter disc to exert a downward force from the threaded connection between the inlet manifold and the compression nut, through the tank adapter disc, and against the tank wall surrounding the threaded tank port. The resilient O-ring is positionable between the tank adapter disc and the wall of the tank to primarily provide vibration damping in order to prevent the tank adapter disc from marring the surface of the tank wall.

By creating this force at the inlet manifold and distributed against the wall of the tank about the periphery of the threaded tank port, any moment of force created by the cantilevered weight of the fuel transfer pump assembly's, motor, electronics, and nozzle assemblies is counteracted. This is believed to reduce the otherwise stress concentration and possible fatigue at the weld between the tank wall and the threaded tank port.

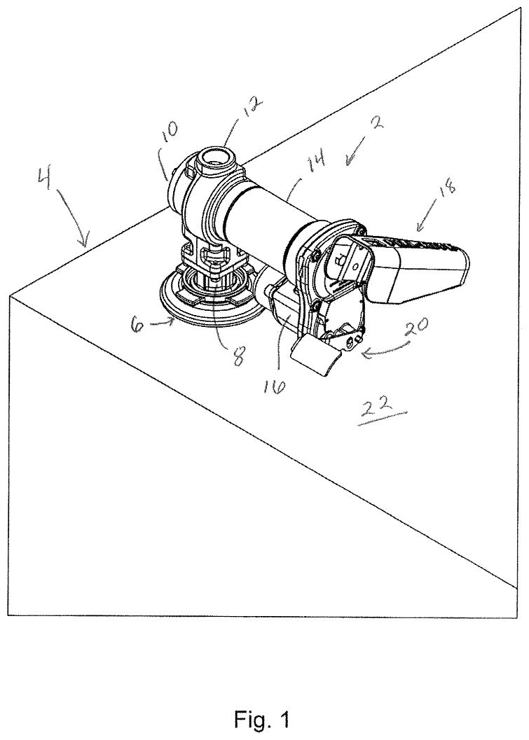

An illustrative embodiment of a fuel or fluid transfer pump 2, shown attached to an illustrative fuel or fluid tank 4, with an embodiment of a mounting adapter assembly 6, is shown in FIG. 1. Fluid transfer pump 2 includes an inlet manifold 8 shown attached to fluid tank 4 and in communication with pump assembly 10 located there above. Illustrative outlet manifold 12 is also illustratively located in line with pump assembly 10 and inlet manifold 8, above fluid tank 4, as shown. It should be appreciated by the skilled artisan, upon reading this disclosure, that the depicted configuration of inlet manifold 8, pump assembly 10, and outlet manifold 12 are arranged in an illustrative manner. Other arrangements of such structures may be created that are still applicable within the scope of this disclosure.

In this illustrative embodiment, a motor assembly 14 extends laterally from pump assembly 10. Here, at least a portion of this motor assembly 14 is not positioned directly over the connection between inlet manifold 8 and fluid tank 4. Likewise, electronics compartment 16, nozzle boot 18, and nozzle lever switch 20 are also shown coupled to motor assembly 14 and spaced apart from the connection between inlet manifold 8 and fluid tank 4. A nozzle (not shown) may be fitted into nozzle boot 18 and supported by nozzle lever switch 20 when not in use. A hose may extend from outlet manifold 12 to the nozzle for purposes of dispensing fluid from fluid tank 4 to another container. Nonetheless, the nozzle, when located in nozzle boot 18 and supported by nozzle lever switch 20, adds further weight spaced apart from the connection between inlet manifold 8 and fluid tank 4 as further explained herein, but evident from this view. To that end, several of the structures from fluid transfer pump 2 may create a moment of force at the connection between fluid tank 4 and inlet manifold 8, induced by the cantilevered structures of fluid transfer pump 2 extending laterally away from pump assembly 10 located over inlet manifold 8.

An illustrative mounting adapter assembly 6 is shown attached to inlet manifold 8 and engaging outer wall surface 22 of fluid tank 4 to reverse the load created by the moment of force induced by the cantilevered pump load. It is appreciated that mounting adapter assembly 6 distributes this counteracting downward force onto fluid tank 4. In this way, such cantilevered fuel transfer pump 2 may have expanded applications to tank structures that may not otherwise be able to support such pumps.

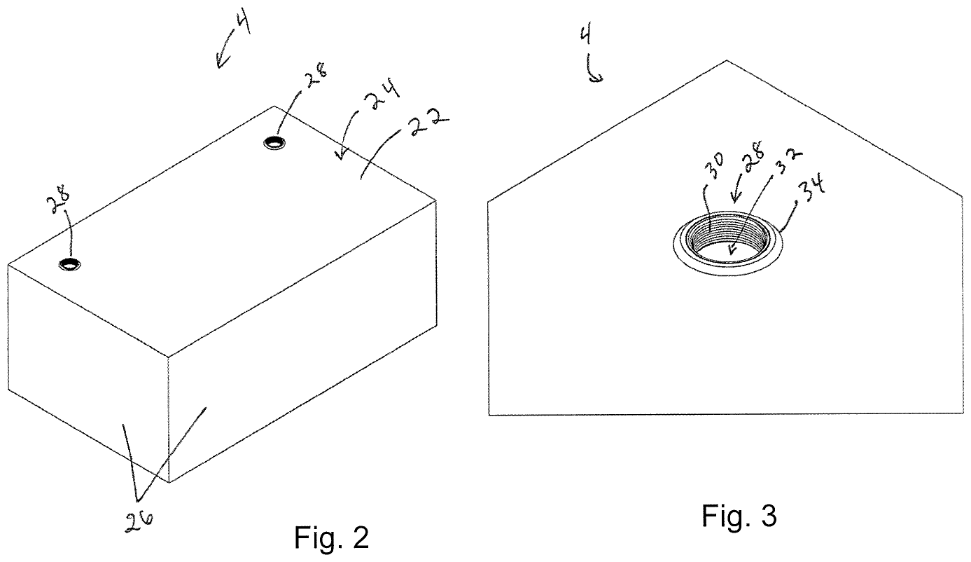

Perspective and detail perspectives views of fluid tank 4 are shown in FIGS. 2 and 3, respectively. The perspective view of fluid tank 4, shown in FIG. 2, may illustratively be a portable aluminum fuel tank. Such fuel tanks may be carried in the cargo box of pickup trucks. Typical fluid tanks for this type of application commonly include aluminum or thin-walled steel construction. These tanks may be installed in a variety of places, but the applications most affected are those that experience vibration during recurring transportation. Another application may be a static tank location that employs the use of a hand operated pump. In this case, the mounting adapter assembly may help to counteract the input forces required to operate the pump.

The illustrative tank shown here is composed of top wall 24 having an outer wall surface 22 and a plurality of sidewalls 26 and bottom wall (not shown) to form a container. The particular size and configuration of the fluid tank can vary and the adapters of the present disclosure may be employed on many of them, so long as they have a tank opening, port, or connection location configured to receive a pump, such as a cantilevered pump. As such, it is appreciated that the tank herein is illustrative.

Because fluid tank 4 is illustrative, it may be made of aluminum and employing one or more tank ports 28. In the illustrated embodiment herein, fluid tank 4 includes multiple tank ports 28. This is to allow attachment of the pump, such as fluid transfer pump 2 shown in FIG. 1 on either side of fluid tank 4. The positioning of the pump may be dictated by the convenience of an operator. Whichever tank opening port 28 is employed, the other may be equipped with an appropriate vent cap so that the tank may be adequately vented while pumping or during thermal expansion or contraction of the fluid.

As shown in the perspective detail view of FIG. 3, tank port 28 illustratively includes a plurality of threads 30 located about the periphery of opening 32 in tank port 28 as shown. It is appreciated that threads 30 may be standard size, such as National Pipe Tapered (NPT) or British Standard Pipe (BSP). Other means of mechanically affixing to inlet manifold 8 may be employed as well. Oftentimes, tank port 28 may also be referred to as a bung and is a separate structure that, in the case of aluminum tanks, is welded to the periphery of opening 32 in fluid tank 4. In the illustrated embodiment, shown herein, a tank weld 34 may exist at the periphery of tank port 28 to secure same to fluid tank 4. A fracture will typically begin in the toe of the weld and propagate circumferentially around the weld. Other contributing factors that could create the fracture in this area may include residual stresses, various properties of the heat affected zone, and in the case of aluminum tanks, aluminum does not have a true endurance limit, so fatigue may inevitably cause problems. Aluminum would weld with aluminum filler or using an alternative process such as brazing. Steel could be welded with steel filler or using an alternative process such as brazing.

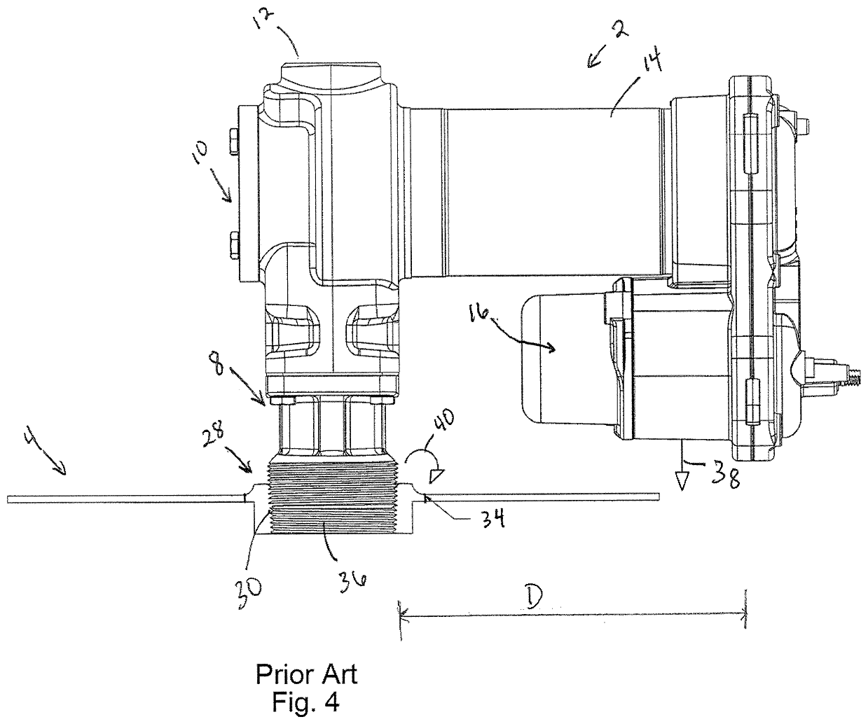

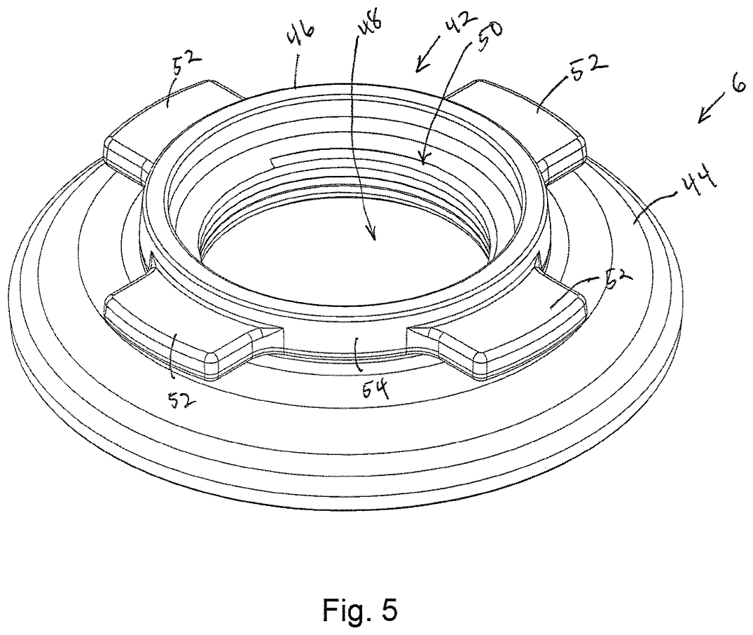

A side elevational view showing a portion of fluid tank 4, in cross-section with fluid transfer pump 2, coupled thereto at tank port 28, is depicted in Prior Art FIG. 4. Here, threaded surface 36 of inlet manifold 8 is threaded onto threads 30 of tank port 28 securing fluid transfer pump 2 onto fluid tank 4. Furthering the view of FIG. 1, here in FIG. 4, it is appreciated how pump assembly 10 and outlet manifold 12 are vertically oriented in line with tank port 28. However, motor assembly 14, electronics compartment 16, and nozzle support (not shown in this view, but may include nozzle boot 18 and nozzle lever switch 20 shown in FIG. 1) extend laterally from pump assembly 10 and are not positioned directly over tank port 28. Thus, much of the weight of the pump exists some distance D away from the attaching connection between fluid transfer pump 2 and tank port 28. In this case, the weight of motor assembly 14, electronics compartment 16, and other structures creates a downward force 38 at a location away from tank port 28. A moment of force 40 is, therefore, induced by the cantilevered pump load created by the weight of these structures spaced apart from tank port 28. Because of this, tank weld 34 located about the periphery of tank port 28 is susceptible to fractures. These fractures may propagate about tank port 28, possibly causing failure of tank port 28.

In order to mitigate this potential damage, mounting adapter assembly 6 shown in the perspective view of FIG. 5, is attached to fluid transfer pump 2, shown in FIG. 1, and may be employed to reverse the load on tank port 28 at tank weld 34 to relieve the stress concentration at this area caused by the cantilevered weight of fluid transfer pump 2. As further shown in FIG. 5, mounting adapter assembly 6 may be composed of a tank adapter disc 44 and compression nut 42. As illustratively shown herein, compression nut 42 includes a body 46 that forms an opening 48 with illustrative threads 50 disposed about its periphery. Threads 50 are sized to mate with threaded surface 36 on inlet manifold 8 so as to attach mounting adapter assembly 6 to inlet manifold 8. It is appreciated that compression nut 42 may be adapted to secure to another pump structure that may be attached to a fluid tank that supports the weight of the pump. An objective of the mounting adapter assembly is to reverse at least a portion of the load on the tank created by the cantilevered weight of the pump. As such, if another structure of the pump is employed to attach to the tank and carry the load of other cantilevered structures, but is not the inlet manifold, it is still contemplated that the mounting adapter assembly may be attached to that structure. In other words, the inlet manifold in and of itself (aside from being the structure connected to the tank) is not a limiting feature in the present disclosure.

As further shown in this illustrative embodiment, compression nut 42 includes illustrative tabs 52, illustratively spaced apart and regularly placed about outer periphery 54 of compression nut 42. Tabs 52 may serve to provide engagement structures to allow compression nut 42 to rotate along threaded surface 36 of inlet manifold 8 for moving compression nut 42 linearly.

Tank adapter disc 44 is dimensioned to be sandwiched between compression nut 42 and outer wall surface 22 of fluid tank 4. It is contemplated, that the combination of compression nut 42 and tank adapter disc 44 will create a downward force against outer wall surface 22, but spaced apart from tank port 28 to create a desired counteracting force.

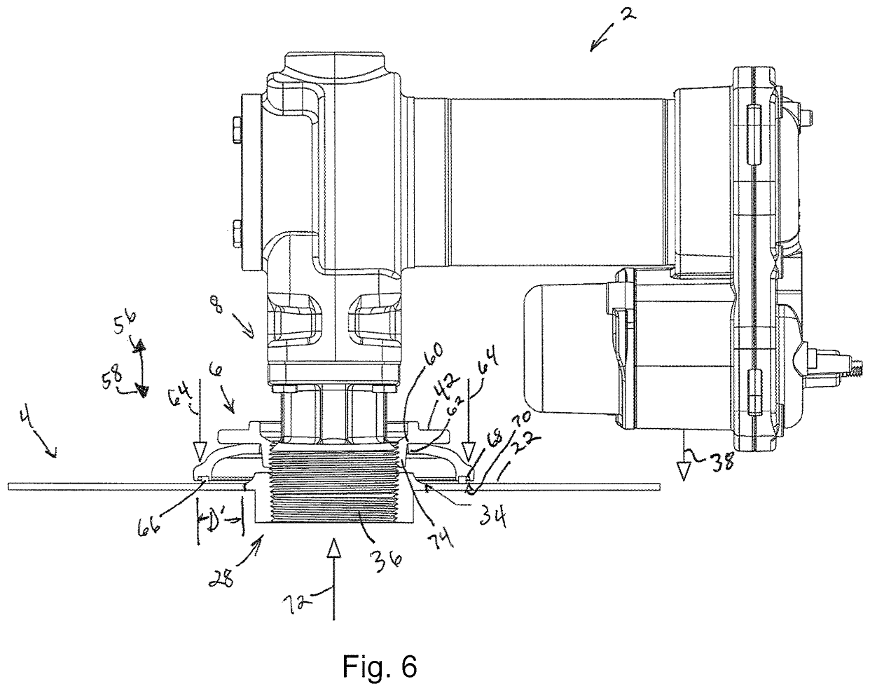

Another side elevational view showing a portion of fluid tank 4 in cross-section with fluid transfer pump 2, coupled to both tank port 28 and mounting adapter assembly 6, is shown in FIG. 6. This view depicts how mounting adapter assembly 6 counteracts the cantilevered load from fluid transfer pump 2 from tank port 28. Under normal conditions such as that discussed with respect to FIG. 4, downward force 38 is spaced apart from tank port 28, which would otherwise cause a moment of force, such as the moment of force 40 shown in FIG. 4. As shown in FIG. 6, however, compression nut 42 is threadably coupled to threaded surface 36 of inlet manifold 8 by rotating compression nut 42 about threaded surface 36. Compression nut 42 is, thus, movable linearly in directions 56 and 58. In this illustrative embodiment, compression nut 42 has a collar 60 illustratively located on the underside and facing tank adapter disc 44 adjacent opening 62 of tank adapter disc 44. Opening 62 is sized and adapted to allow both at least a portion of inlet manifold 8 and threads 50 of compression nut 42 to be disposed therethrough. This allows compression nut 42 to apply an increasing downward force against tank adapter disc 44 toward outer wall surface 22 of fluid tank 4 as compression nut 42 moves linearly in direction 58. By rotating compression nut 42, it is possible for the mating threads 50 and threaded surface 36 to cause compression nut 42 to move in direction 58 creating this downward force against tank adapter disc 44 to create a downward force 64 by tank adapter disc 44 against outer wall surface 22 of tank 4 at a position spaced apart from tank weld 34. Illustratively, tank adapter disc 44 is circular to allow an even distribution of downward force 64 against fluid tank 4. It is appreciated that based on the needs of the downward force and configuration of the tank and port, tank adapter disc 44 may be a variety of shapes, such as oval, square, single point extended from an arm that is in-line with cantilevered load's center of gravity. The skilled artisan, upon reading the present disclosure, will also appreciate the distance D′ that tank adapter disc 44 extends from tank weld 34 may vary based on the needed counteracting force and/or potential obstructions about tank port 28.

Also shown in this view is resilient O-ring 66 located in an illustrative cavity 68 on the underside surface 70 of tank adapter disc 44. Downward force 64 causes tank adapter disc 44 to sandwich resilient O-ring 66 between underside surface 70 and outer wall surface 22. This provides a seal between tank adapter disc 44 and fluid tank 4 about the periphery of tank port 28. O-ring 66 may also assist in distributing downward force 64 about outer wall surface 22. The resulting effect of mounting adapter assembly 6 onto fluid tank 4 is that, despite downward force 38 still being applied, there is no substantial moment of force 40 acting on tank weld 34. Rather, there is an upward force 72, but that is just a linear force opposing downward forces 38 and 64. Because downward force 64 reverses the cantilevered load of downward force 38, no moment of force is created at tank weld 34 to produce a stress concentration and potential fractures. The O-ring is intended to provide vibration damping to the system, but also serves to accommodate disparities or unevenness in the tank wall top (e.g., diamond plate texture) so as to not mar the surface and create consistent preload over time.

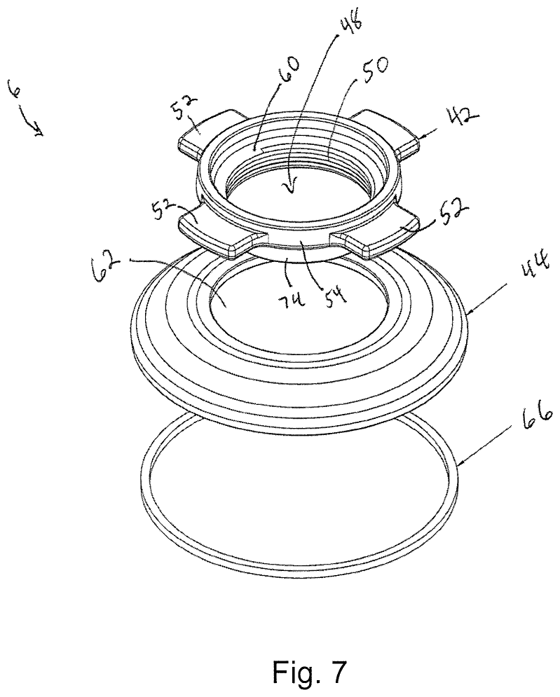

An exploded view of mounting adapter assembly 6 is shown in FIG. 7. Compression nut 42 is shown with opening 48, bounded by threads 50 terminating at collar 60. Tabs 52 are also shown regularly positioned about outer periphery 54 of compression nut 42. Tank adapter disc 44 is shown having opening 62 disposed therethrough in order to receive a portion of lower collar 74 of compression nut 42. It will be appreciated by the skilled artisan upon reading this disclosure, that the concave shape of tank adapter disc 44 is illustrative. Tank adapter disc 44 may have other like body profiles that still engage fluid tank 4 at a spaced apart location from tank port 28. The amount of spacing such as distance D′ shown in FIG. 6 can be adjusted based on the needs of the particular pump and/or tank employed.

Also shown in this view is resilient O-ring 66 sized to be placed underneath tank adapter disc 44 and pressed against outer wall surface 22 of fluid tank 4 (see, also, FIG. 6). In an illustrative embodiment, resilient O-ring 66 fits into cavity 68 of underside surface 70 of tank adapter disc 44 in order to have a consistent seat. It is appreciated, however, that in other embodiments, such O-ring 66 or other like seal or compression member may not be required to fit into a channel in order to be sandwiched between a compression structure and fluid tank. While it is the mounting adapter assembly that results in pressing against the fluid tank, the O-ring may not be required to be the structure actually pressing against the tank. In further embodiments, no O-ring or other like member may be employed. Alternatively, the O-ring may be integrally formed with tank adapter disc 44.

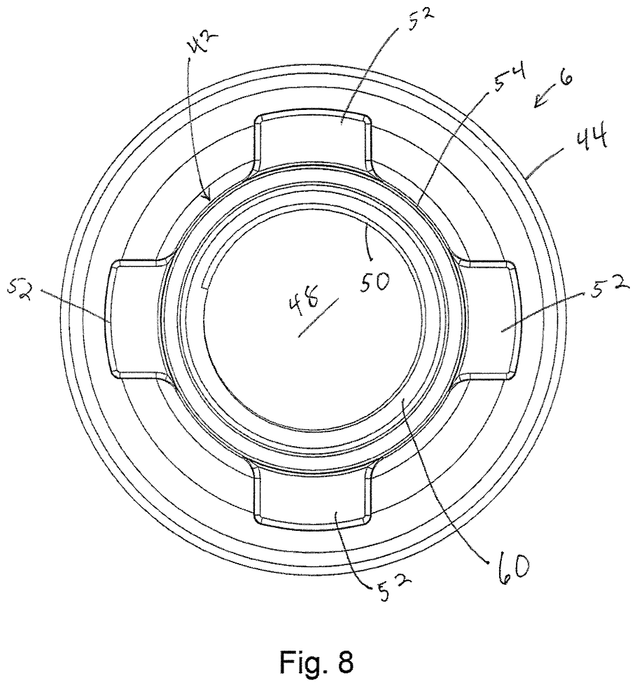

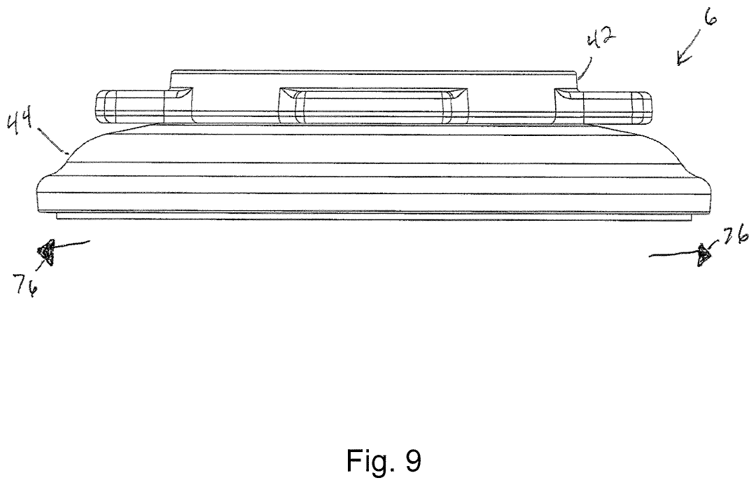

A top view of mounting adapter assembly 6 is shown in FIG. 8. This view depicts tabs 52 extending from outer periphery 54 of compression nut 42. Collar 60 is also shown on the interior of compression nut 42 adjacent opening 48 and threads 50. This view further shows compression nut 42 disposed in tank adapter disc 44 extending therefrom. It is appreciated that tank adapter disc 44 is sized to shroud tank port 28 in order to provide a compression force against fluid tank 4 at a location extended from tank port 28. This is further appreciated in the side view of mounting adapter assembly 6 of FIG. 9 which shows tank adapter disc 44 extending radially from compression nut 42 in direction 76. It is appreciated that the extent to which tank adapter disc 44 extends from compression nut 42 in direction 76 is dependent on where a suitable location from the tank port exists to reverse the load created by a pump.

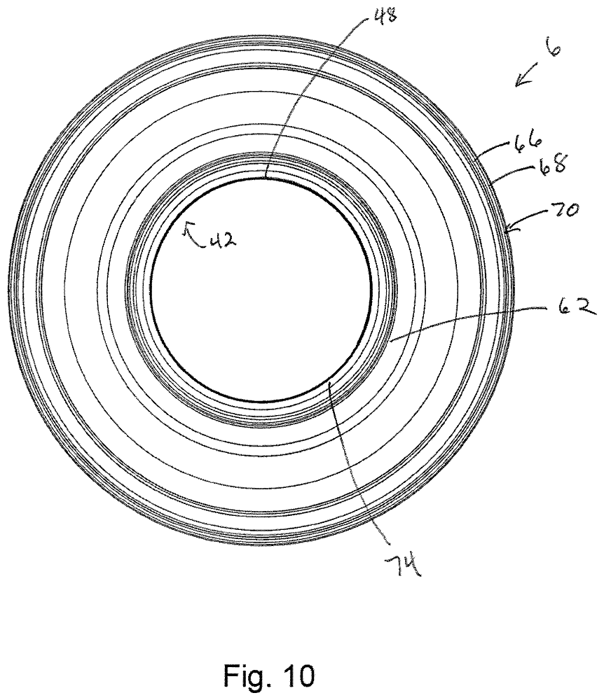

An underside view of mounting adapter assembly 6 is shown in FIG. 10. This view further depicts how resilient O-ring 66 fits into cavity 68 on underside surface 70 of tank adapter disc 44. This view demonstrates how both tank adapter disc 44 and O-ring 66 encircle opening 62 of tank adapter disc 44 and opening 48 of compression nut 42 in order to receive inlet manifold 8 (see, also, FIG. 6). Also shown in this view is lower collar 74 which fits into opening 62 of tank adapter disc 44 (see, also, FIG. 6). Again, the diameter of tank adapter disc 44 may vary and may be of a different configuration (such as oval, square, rectangular, etc.) as needed in order to provide a compressive force on a fluid tank. It is further appreciated that openings 48 and 62 may be sized to accommodate other pumping structures other than an inlet manifold depending on the configuration of the cantilever pump structure itself. This could extend to other types of pumps with electric motors, or even hand pumps that are subject to external input that create large moments about the tank port through operating the pump.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that, to the extent any subject matter disclosed in this non-provisional patent document conflicts with the priority application, the disclosure from this non-provisional patent document controls.

What is claimed:

1. A tank mounting adapter to be located adjacent a support structure of a fluid pump that attaches to a fluid tank, wherein the support structure supports the fluid pump on the fluid tank, the tank mounting adapter comprising:
a tank adapter disc;
wherein the tank adapter disc includes an opening disposed therethrough and sized to receive at least a portion of the support structure of the fluid pump; and
a compression nut;
wherein the compression nut includes a collar with a threaded opening disposed therethrough such that threads of the threaded opening are configured to correspond to threads on the support structure of the fluid pump;
wherein the compression nut is located adjacent the tank adapter disc;
wherein the collar includes a lower portion that extends into the opening of the tank adapter disc;
wherein the compression nut is rotationally and linearly movable with respect to the tank adapter disc and against the tank adapter disc; and
wherein the tank adapter disc is extended in a direction transverse from the threaded opening of the compression nut.

2. The tank mounting adapter of claim 1, further comprising an O-ring located on the tank adapter disc opposite the compression nut.

3. The tank mounting adapter of claim 1, further comprising an O-ring located at least partially within a cavity formed on an underside of the tank adapter disc opposite the compression nut.

4. The tank mounting adapter of claim 2, wherein the O-ring is located at least partially within a cavity formed on an underside of the tank adapter disc opposite the compression nut.

5. The tank mounting adapter of claim 2, wherein the O-ring is made of a resilient material.

6. The tank mounting adapter of claim 1, wherein the compression nut further comprises at least one tab extending therefrom.

7. The tank mounting adapter of claim 6, wherein the at least one tab is a plurality of tabs, wherein each of the plurality of tabs is spaced apart from each other and extending outwardly from the compression nut.

8. The tank mounting adapter of claim 1, wherein the lower portion of the collar that extends into the opening of the tank adapter disc is also located adjacent a periphery of the opening of the tank adapter disc.

9. The tank mounting adapter of claim 1, wherein the compression nut exerts a downward force against the tank adapter disc.

10. The tank mounting adapter of claim 1, wherein at least a portion of the tank adapter disc has a concave shape.

11. The tank mounting adapter of claim 10, wherein the concave shape of the at least the portion of tank adapter disc is located opposite of at least a portion of the compression nut.

12. The tank mounting adapter of claim 1, wherein the tank adapter disc has a shape that is selected from the group consisting of at least one of an oval, a square, and a rectangle.

13. A tank mounting adapter comprising:
a tank adapter disc;
wherein the tank adapter disc includes an opening disposed therethrough; and
a compression nut;
wherein the compression nut includes a collar with a threaded opening disposed therethrough;
wherein the compression nut is located adjacent the tank adapter disc; and
wherein the compression nut is movable against the tank adapter disc.

14. The tank mounting adapter of claim 13, wherein the collar includes a lower portion that extends into the opening of the tank adapter disc.

15. The tank mounting adapter of claim 13, wherein the compression nut is rotationally and linearly movable with respect to the tank adapter disc.

16. The tank mounting adapter of claim 13, wherein the tank adapter disc is extended in a direction transverse from the threaded opening of the compression nut.

17. A tank mounting adapter comprising:
a tank adapter disc;
wherein the tank adapter disc includes an opening disposed therethrough; and
a compression nut;
wherein the compression nut includes a collar with a threaded opening disposed therethrough; and
wherein the compression nut is movable against the tank adapter disc.

18. The tank mounting adapter of claim 17, wherein the compression nut is located adjacent the tank adapter disc.

19. The tank mounting adapter of claim 17, wherein the tank adapter disc is extended in a direction transverse from the threaded opening of the compression nut.

20. The tank mounting adapter of claim 17, wherein the collar includes a lower portion that extends into the opening of the tank adapter disc.
